(19) United States
(12) Patent Application Publication
(10) Pub. No.: US 2025/0091559 A1
(43) Pub. Date: Mar. 20, 2025

(54) BRAKE SYSTEM AND VEHICLE

(71) Applicant: ZF Active Safety GmbH, Koblenz (DE)

(72) Inventor: Roman Bechmann, Koblenz (DE)

(21) Appl. No.: 18/884,696

(22) Filed: Sep. 13, 2024

(30) Foreign Application Priority Data
Sep. 15, 2023 (DE) 102023125074.4

(51) Int. Cl. B60T 13/58; B60T 13/62; B60T 13/74

(52) U.S. Cl. CPC B60T 13/588; B60T 13/62; B60T 13/746; B60T 2220/04; B60T 2240/00; B60T 2270/402; B60T 2270/404; B60T 2270/413; B60T 2270/414

(57) ABSTRACT

The disclosure relates to a brake system for a vehicle having four brakeable wheels, the brake system comprising an actuation unit for detecting a driver braking request, a main brake module, which comprises a hydraulic brake actuator unit, which is configured for braking the front wheels, and an electromechanical brake actuator unit, which is configured for braking the rear wheels, and having a hydraulic auxiliary brake module, which is coupled hydraulically to the hydraulic brake actuator unit for braking the front wheels and is connected electronically to the electromechanical brake actuator unit. In addition, a vehicle having a brake system is also disclosed.

### CROSS-REFERENCE TO RELATED APPLICATIONS

This application claims priority to DE Patent Application No. 102023125074.4 filed on Sep. 15, 2023, the disclosure of which is incorporated herein by reference in its entirety.

### TECHNICAL FIELD

The disclosure relates to a brake system for a vehicle having at least four brakeable wheels and to a vehicle having a brake system.

In particular, the brake system comprises a main brake module having a hydraulic brake actuator unit, which is configured for braking the front wheels, and an electromechanical brake actuator unit, which is configured for braking the rear wheels.

### BACKGROUND

Brake systems that serve as service brakes must have a sufficiently high level of fail safety to enable an adequate braking power to be ensured in all cases in order to allow the vehicle to be driven safely to a destination or at least to be safely parked.

In the case of hydraulic brake systems, in which all the wheels of the vehicle are actuated by a hydraulic brake actuator unit, the vehicle can still be handled safely by a hydraulic through connection if the electronics fail.

However, hydraulic systems are complex and require a large amount of installation space.

In the case of electronic brake systems which do not include hydraulics, some components of the brake system, e.g. communication lines, must be redundant, thereby likewise making the brake system complex and expensive.

What is needed is to specify a brake system which has a high level of fail safety and, at the same time, is of compact and low-cost design.

### SUMMARY

According to the disclosure, a brake system for a vehicle having at least four brakeable wheels is disclosed. The brake system has an actuation unit for detecting a driver braking request, a main brake module, which comprises a hydraulic brake actuator unit, which is configured for braking the front wheels, and an electromechanical brake actuator unit, which is configured for braking the rear wheels, and having a hydraulic auxiliary brake module, which is coupled hydraulically to the hydraulic brake actuator unit for braking the front wheels and is connected electronically to the electromechanical brake actuator unit.

Since the front wheels are braked by a hydraulic brake actuator unit, and the rear wheels are braked by an electromechanical brake actuator unit, the share of the hydraulics in the brake system is reduced, thereby simplifying the brake system.

The auxiliary brake module, which is coupled hydraulically to the hydraulic brake actuator unit for braking the front wheels, represents a fallback level, ensuring that the braking power at the front wheels is not impaired if there is a fault in the hydraulic brake actuator unit of the main brake module.

The fail safety is additionally enhanced by the fact that the hydraulic auxiliary brake module is connected electronically to the electromechanical brake actuator unit. This enables the electromechanical brake actuator unit to be controlled via the auxiliary brake module.

The electromechanical brake actuator unit can additionally serve as a parking brake.

Both the main brake module and the auxiliary brake module comprise a dedicated control unit. The brake system therefore has two independent control units, thus providing additional redundancy. As a result, not only can signals for the electromechanical brake actuator unit be transmitted to the electromechanical brake actuator unit via the auxiliary brake module but, in the event of a failure of the electronics of the main brake module, the electromechanical brake actuator unit can be controlled directly by the auxiliary brake module. In addition, the hydraulic brake actuator unit of the main brake module can be controlled by the control unit of the auxiliary brake module when required.

According to one exemplary arrangement, the electromechanical brake actuator unit comprises two electromechanical brake actuators, wherein each rear wheel is assigned an electromechanical brake actuator. In this way, a sufficiently high braking force can be exerted on the rear wheels. In addition, the use of two independent electromechanical brake actuators makes it possible to brake the two rear wheels independently of one another. That is to say that, if one of the two brake actuators fails, it is still possible for at least one of the rear wheels to be braked and thus to contribute to the overall braking power.

The brake system can comprise a first power supply unit and a second power supply unit, wherein the first power supply unit supplies the control unit of the main brake module and one of the two brake actuators with electric power, and the second power supply unit supplies the control unit of the auxiliary brake module and the additional one of the two brake actuators with electric power. Due to the interconnection of the two power supply units, it is still possible to brake the front wheels and one of the two rear wheels if one power supply unit fails, whereby a sufficiently high braking power for safe guidance of the vehicle is achieved.

The actuation unit for detecting a driver braking request is coupled hydraulically to the hydraulic brake actuator unit, for example. In other words, the actuation unit is a component part of the main brake module, wherein a hydraulic direct connection of the actuation unit to the hydraulic brake actuator unit is possible. This means that, even if there is a complete failure of the electronics of the brake system, a certain brake pressure is still possible by actuating the actuation unit.

In an alternative arrangement, the actuation unit for detecting a driver braking request is coupled electronically to the main brake module and the auxiliary brake module. The actuation unit is thus arranged separately from the main brake module, and therefore a hydraulic through connection to the hydraulic brake actuator unit is not possible. In this context, the term “brake-by-wire” brake system is also used, in which system a braking request by a driver is detected purely electronically.

In a “brake-by-wire” brake system, the actuation unit can be connected by signals both to the control unit of the main brake module and to the control unit of the auxiliary brake module.

The main brake module can be connected electronically to the auxiliary brake module, wherein the control unit of the main brake module is connected electronically to the control unit of the auxiliary brake module. This allows a signal exchange between the main brake module and the auxiliary brake module. For example, the control unit of the main brake module can communicate a braking request by the driver to the auxiliary brake module in the event of a failure of the mechanical components of the hydraulic brake actuator unit. In the case of a “brake-by-wire” brake system, it is thus possible, even in the event of a failure of one of the signal lines between the actuation unit and the main brake module or the auxiliary brake module, to pass on the brake signal accordingly.

Each wheel can be assigned a wheel speed sensor, wherein the wheel speed sensors assigned to the front wheels are connected electronically to the main brake module, and the wheel speed sensors assigned to the rear wheels are each connected electronically to one of the brake actuators. Due to the wheel speed sensors, it is possible to balance the braking power at the different wheels of the vehicle.

In one exemplary arrangement, both the main brake module and the auxiliary brake module comprise a respective hydraulic pump. The hydraulic pump of the main brake module is, for example, a component part of the hydraulic brake actuator unit. Since both the main brake module and the auxiliary brake module have a hydraulic pump, the fail safety of the brake system is further enhanced.

According to the disclosure, a vehicle having a brake system according to the disclosure and having a vehicle bus system, is also disclosed, wherein the electromechanical brake actuator unit is coupled to the vehicle bus system by signals. In addition to the advantages already described in connection with the brake system, it is possible in the case of a vehicle of this kind to pass on signals to the electromechanical brake actuator unit, for example to the two brake actuators, via the vehicle bus system, even when the signal link with the control units of the main brake module and the auxiliary brake module has been interrupted.

If, for example, braking is taking place at the front wheels and a corresponding deceleration is detected by the wheel speed sensors, the information on the vehicle deceleration can be passed on to the brake actuators, wherein the latter accordingly apply an auxiliary braking force to the rear wheels.

For this purpose, the electromechanical brake actuator unit may comprise at least one further control unit. For example, each brake actuator is assigned a control unit.

### BRIEF DESCRIPTION OF THE DRAWINGS

Further advantages and features of the disclosure will become apparent from the following description and from the appended drawings, to which reference is made. In the drawings:

FIG. 1 shows schematically a vehicle according to the disclosure having a brake system according to the disclosure in accordance with a first exemplary arrangement, wherein normal operation of the brake system is illustrated,

FIG. 2 shows schematically the vehicle from FIG. 1, wherein a failure of the hydraulic brake actuator unit of the main brake module is illustrated,

FIG. 3 shows schematically the vehicle from FIG. 1, wherein a failure of the hydraulic brake actuator unit of the main brake module and of the auxiliary brake module is illustrated,

FIG. 4 shows schematically the vehicle from FIG. 1, wherein a failure of a power supply unit is illustrated,

FIG. 5 shows schematically a vehicle according to the disclosure having a brake system according to the disclosure in accordance with another exemplary arrangement, wherein normal operation of the brake system is illustrated,

FIG. 6 shows schematically the vehicle from FIG. 5, wherein a failure of the hydraulic brake actuator unit of the main brake module is illustrated, and

FIG. 7 shows schematically the vehicle from FIG. 5, wherein a failure of a power supply unit is illustrated.

### DETAILED DESCRIPTION

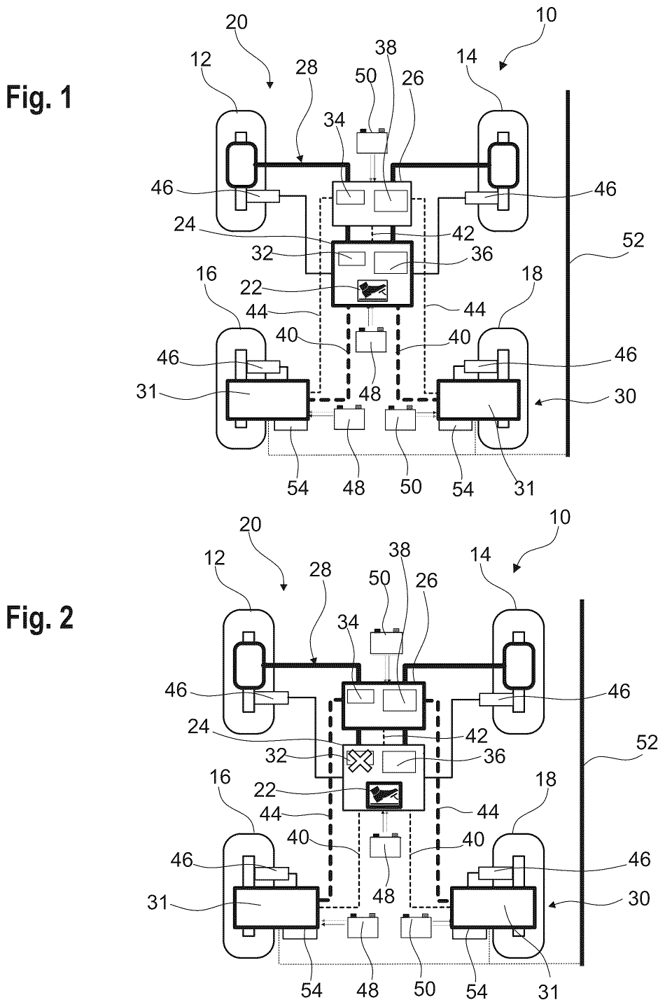

FIG. 1 illustrates schematically a vehicle 10 having four brakeable wheels 12, 14, 16, 18 and having a brake system 20.

The brake system 20 has an actuation unit 22 for detecting a driver braking request, a main brake module 24 and a hydraulic auxiliary brake module 26.

In one exemplary arrangement, the actuation unit 22 comprises a pedal, which can be actuated by a driver's foot to indicate a braking request.

A braking request by a driver may be detected electronically.

The main brake module 24 comprises a hydraulic brake actuator unit 28, which is configured for braking the front wheels 12, 14, and an electromechanical brake actuator unit 30, which is configured for braking the rear wheels 16, 18.

For example, the main brake module 24 has a hydraulic pump 32 and optionally valves to enable a hydraulic pressure to be built up in the hydraulic brake actuator unit 28.

The electromechanical brake actuator unit 30 comprises two electromechanical brake actuators 31, wherein each rear wheel 16, 18 is assigned an electromechanical brake actuator 31.

The hydraulic auxiliary brake module 26 is coupled hydraulically to the hydraulic brake actuator unit 28 for braking the front wheels. That is to say that the hydraulic brake actuator unit 28 can be actuated both by the main brake module 24 and by the auxiliary brake module 26.

For this purpose, the hydraulic auxiliary brake module 26 likewise comprises a hydraulic pump 34.

Both the main brake module 24 and the auxiliary brake module 26 comprise a dedicated control unit 36, 38.

The control unit 36 of the main brake module 24 is connected to the electromechanical brake actuator unit 30 by signals via signal lines 40. To be more precise, the control unit 36 is connected to each of the two electromechanical brake actuators 31 via a respective signal line 40.

The main brake module 24 is connected to the auxiliary brake module 26 by signals via a signal line 42, enabling the main brake module 24 to exchange data with the auxiliary brake module 26. To be more precise, the control unit 36 of the main brake module 24 is connected electronically to the control unit 38 of the auxiliary brake module 26.

The auxiliary brake module 26 is likewise connected to the electromechanical brake actuator unit 30 by signals. To be more precise, the control unit 38 of the auxiliary brake module 26 is connected to each of the two electromechanical brake actuators 31 via a respective signal line 44.

Consequently, the electromechanical brake actuators 31 can be controlled by the control unit 36 of the main brake module 24 and by the control unit 38 of the auxiliary brake module 26.

In the exemplary arrangement shown in FIG. 1, the actuation unit 22 is coupled hydraulically to the hydraulic brake actuator unit 28.

Each wheel 12, 14, 16, 18 is assigned a wheel speed sensor 46, wherein the wheel speed sensors 46 assigned to the front wheels 12, 14 are connected electronically to the main brake module 24, for example to the control unit 36, and the wheel speed sensors 46 assigned to the rear wheels 16, 18 are each connected electronically to one of the brake actuators 31.

The brake system 20 furthermore comprises a first power supply unit 48 and a second power supply unit 50.

The first power supply unit 48 is connected to the control unit 36 of the main brake module 24 and one of the two brake actuators 31 and supplies them with electric power.

The second power supply unit 50 is connected to the control unit 38 of the auxiliary brake module 26 and the additional one of the two brake actuators 31 and supplies them with electric power.

In the figures, the first power supply unit 48 and the second power supply unit are shown in duplicate for the purposes of illustration.

The vehicle 10 has a vehicle bus system 52, to which the electromechanical brake actuator unit 30 is coupled by signals. In this way, information can be transferred to the brake actuators 31 even when signal transmission between the control unit 36 of the main brake module 24 as well as the auxiliary brake module 26 and the brake actuators 31 has been interrupted.

The operation of the brake system 20 will be described below with reference to FIGS. 1 to 4.

FIG. 1 illustrates a braking operation in which the brake system 20 is functioning correctly.

In this case, a braking request by a driver is correctly detected from the actuation of the actuation unit 22 and processed in the control unit 36 of the main brake module 24.

In accordance with the brake signal, both the hydraulic brake actuator unit 28 and the electromechanical brake actuator unit 30 are controlled by the control unit 36 in order to build up a braking force at the wheels 12, 14, 16, 18.

This is accomplished by operation of the hydraulic pump 32 of the main brake module 24 in the case of the hydraulic brake actuator unit 28 and by the brake actuators 31 in the case of the electromechanical brake actuator unit 30.

For the sake of illustration, the active modules and signal lines are shown with a thick outline or with a thicker line in FIG. 1.

In this case, the auxiliary brake module 26 is in standby, but it is not actively participating in the braking process.

In the scenario illustrated in FIG. 1, a braking performance of 100% is achieved.

FIG. 2 illustrates a scenario in which the main brake module 24 has a fault. The hydraulic pump 32 has failed, for example.

The actuation unit 22 is continuing to function correctly, thus enabling a braking request by a driver to be detected and processed.

For example, a braking request by a driver is passed on to the control unit 38 of the auxiliary brake module 26 via the signal line 42.

The auxiliary brake module 26 then activates the electromechanical brake actuator unit 30 and builds up a hydraulic pressure in the hydraulic brake actuator unit 28 by the hydraulic pump 34.

The auxiliary brake module 26 can thus fully compensate for the malfunction of the main brake module 24 and, as a result, a braking performance of 100% continues to be achievable.

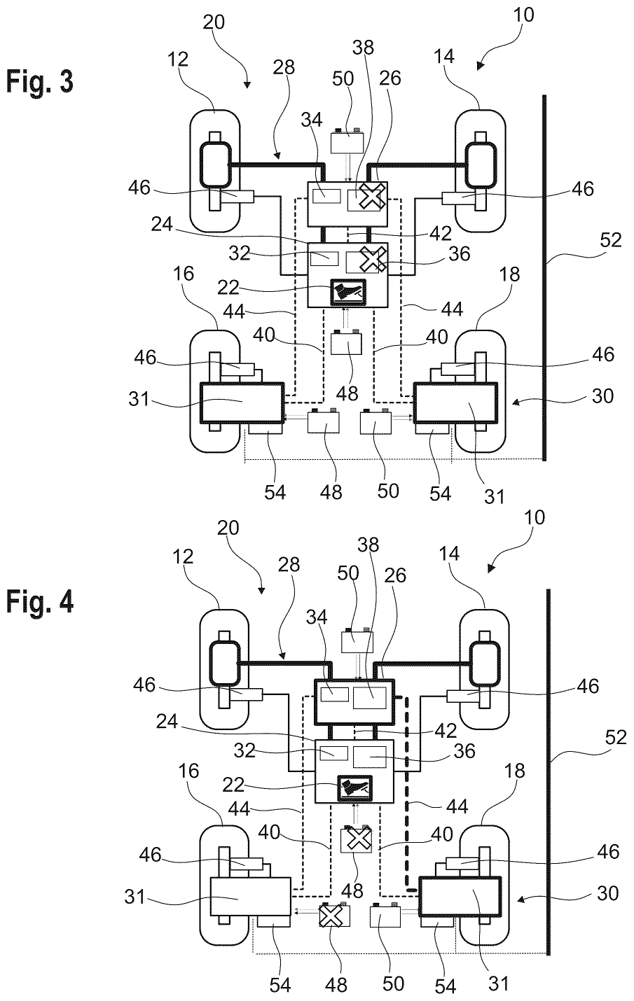

FIG. 3 illustrates a scenario in which both the main brake module 24 and the auxiliary brake module 26 have failed.

In this case, both hydraulic pumps 32, 34 are out of operation.

However, since the actuation unit 22 is coupled hydraulically to the hydraulic brake actuator unit 28, a hydraulic through connection of the actuation unit 22 is possible. This means that, by actuating the actuation unit 22, for example by depressing the brake pedal, a hydraulic pressure can be built up in the hydraulic brake actuator unit 28 and thus a braking effect can be achieved.

Due to the hydraulic through connection, it is possible to achieve a braking performance of approximately 70%, this being sufficient to be able to manoeuvre the vehicle 10 safely.

There is no signal transmission by the control units 36, 38 to the electromechanical brake actuator unit 30.

As an option, however, it is conceivable for the brake actuator unit 30 to receive information on a braking process via the vehicle bus system 52 and then to control the brake actuators 31 accordingly.

More specifically, it is possible, during a braking process, for a vehicle deceleration to be detected by wheel speed sensors 46 assigned to the front wheels 12, 14.

This vehicle deceleration is communicated via the vehicle bus system 52 to the electromechanical brake actuator unit 30, whereupon the brake actuators 31 are controlled accordingly and can thus contribute to the braking performance. It is thereby possible to achieve a braking performance of significantly over 70%.

For this purpose, the brake actuators 31 may each have a dedicated control unit 54.

FIG. 4 illustrates a scenario in which the first power supply unit 48 has failed.

As a result, the main brake module 24 and one of the brake actuators 31 is no longer being supplied with electric power.

In this case, in a manner similar to the scenario already described in connection with FIG. 2, the auxiliary brake module 26 takes over the control of the hydraulic brake actuator unit 28 and of the remaining, right-hand brake actuator 31.

In this way, a braking performance of approximately 85% is achieved.

If, instead of the first power supply unit 48, the second power supply unit 50 fails, the main brake module 24 remains active, with only one of the brake actuators 31 failing. This likewise leads to a braking performance of approximately 85%.

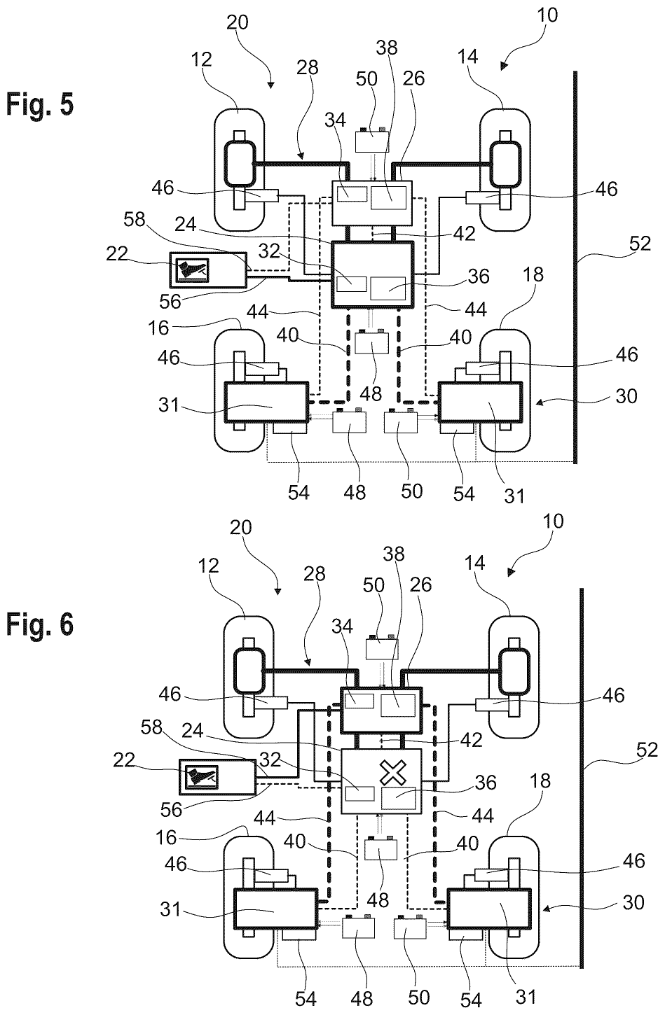

FIG. 5 illustrates another vehicle 10 having a brake system 20.

In the text which follows, the same reference signs are used for identical structures with identical functions which are known from the above exemplary arrangement, and, to this extent, attention is drawn to the above explanations, while it is the differences between the respective arrangements that are explored below, in order to avoid repetition.

The vehicle 10 illustrated in FIG. 5 differs from the vehicle illustrated in the previous figures in the arrangement of the actuation unit 22.

For example, the actuation unit 22 is not coupled hydraulically to the main brake module 24; instead, the actuation unit 22 is coupled electronically to the main brake module 24 and to the auxiliary brake module 26.

This means that the brake system illustrated in FIG. 5 is a “brake-by-wire” brake system, in which no hydraulic or mechanical through connection can be made to the wheels 12, 14, 16, 18 of the vehicle 10.

To connect the actuation unit 22 electronically, additional signal lines 56, 58 are provided, which connect the actuation unit 22 to the control unit 36 of the main brake module 24 and to the control unit 38 of the auxiliary brake module 26 by signals.

Apart from the fact that hydraulic through connection cannot occur, the operation of the brake system 20 shown in FIG. 5 is identical with that in the brake system 20 described in FIGS. 1 to 4.

If the main brake module 24 fails, as illustrated in FIG. 6, the auxiliary brake module detects a braking signal via the signal line 58 and controls the hydraulic brake actuator unit 28 and the electromechanical brake actuator unit 30 accordingly.

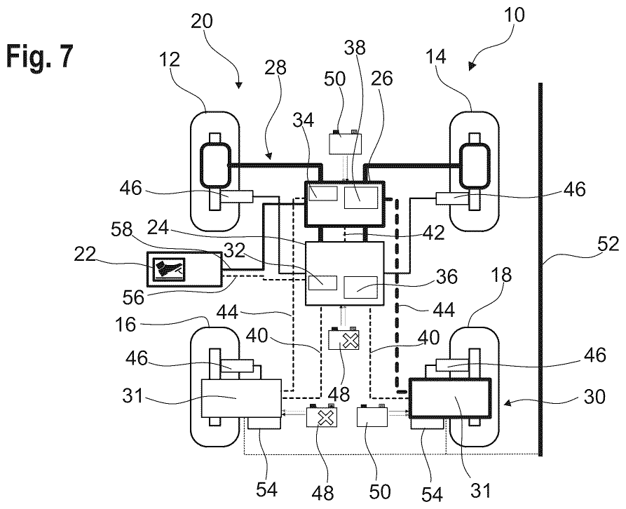

If the first power supply unit 48 fails, as illustrated in FIG. 7, the auxiliary brake module 26 controls the hydraulic brake actuator unit 28 and the remaining brake actuator 31 accordingly.

1. A brake system for a vehicle having four brakeable wheels, comprising:
an actuation unit for detecting a driver braking request,
a main brake module, which comprises a hydraulic brake actuator unit, which is configured for braking the front wheels, and an electromechanical brake actuator unit, which is configured for braking the rear wheels, and
a hydraulic auxiliary brake module, which is coupled hydraulically to the hydraulic brake actuator unit for braking the front wheels and is connected electronically to the electromechanical brake actuator unit.

2. The brake system according to claim 1, wherein both the main brake module and the auxiliary brake module comprise a dedicated control unit.

3. The brake system according to claim 1, wherein the electromechanical brake actuator unit comprises two electromechanical brake actuators, wherein each rear wheel is assigned an electromechanical brake actuator.

4. The brake system according to claim 3, wherein the brake system comprises a first power supply unit and a second power supply unit, wherein the first power supply unit supplies the control unit of the main brake module and one of the two brake actuators with electric power, and the second power supply unit supplies the control unit of the auxiliary brake module and the additional one of the two brake actuators with electric power.

5. The brake system according to claim 1, wherein the actuation unit for detecting a driver braking request is coupled hydraulically to the hydraulic brake actuator unit.

6. The brake system according to claim 1, wherein the actuation unit for detecting a driver braking request is coupled electronically to the main brake module and the auxiliary brake module.

7. The brake system according to claim 1, wherein the main brake module is connected electronically to the auxiliary brake module.

8. The brake system according to claim 1, wherein each wheel is assigned a wheel speed sensor, wherein the wheel speed sensors assigned to the front wheels are connected electronically to the main brake module, and the wheel speed sensors assigned to the rear wheels are each connected electronically to one of the brake actuators.

9. The brake system according to claim 1, wherein both the main brake module and the auxiliary brake module comprise a respective hydraulic pump.

10. A vehicle having a brake system and a vehicle bus system, wherein the brake system comprises an actuation unit for detecting a driver braking request, a main brake module, which comprises a hydraulic brake actuator unit, which is configured for braking a pair of front wheels, and an electromechanical brake actuator unit, which is configured for braking a pair of rear wheels, and a hydraulic auxiliary brake module, which is coupled hydraulically to the hydraulic brake actuator unit for braking the pair of front wheels and is connected electronically to the electromechanical brake actuator unit, wherein the electromechanical brake actuator unit is coupled to the vehicle bus system by signals.

11. The brake system according to claim 4, wherein the actuation unit for detecting a driver braking request is coupled hydraulically to the hydraulic brake actuator unit.

12. The brake system according to claim 4, wherein the actuation unit for detecting a driver braking request is coupled electronically to the main brake module and the auxiliary brake module.

13. The brake system according to claim 7, wherein the control unit of the main brake module is connected electronically to the control unit of the auxiliary brake module.

14. The brake system according to claim 4, wherein each wheel is assigned a wheel speed sensor, wherein the wheel speed sensors assigned to the front wheels are connected electronically to the main brake module, and the wheel speed sensors assigned to the rear wheels are each connected electronically to one of the brake actuators.
